(19) United States
(12) Patent Application Publication
(10) Pub. No.: US 2011/0299751 A1
(43) Pub. Date: Dec. 8, 2011

(54) Method and Apparatus to Facilitate Development of Therapeutic Treatment Plans

(75) Inventors: Janne Nord, Espoo (FI); Juha Kauppinen, Espoo (FI)

(73) Assignee: VARIAN MEDICAL INTERNATIONAL AG, Zug (CH)

(21) Appl. No.: 12/793,312

(22) Filed: Jun. 3, 2010

(51) Int. Cl. G06K 9/00

(52) U.S. Cl. 382/131

(57) ABSTRACT

A digital image processing apparatus acquires first information comprising a first multi-dimensional high-energy study of a given treatment volume for a given person. This apparatus then combines this first information with second information that comprises a second multi-dimensional high-energy study of a given volume for a person that includes, but also exceeds, the given treatment volume. This second multi-dimensional high-energy study precedes in time the first multi-dimensional high-energy study. This combination yields resultant multi-dimensional high-energy image information for the given treatment volume that includes imaging information beyond the given treatment volume. The apparatus then uses this resultant information to facilitate development of a treatment plan for the given person without requiring a projection of the multi-dimensional high-energy image information into sinogram space.

### TECHNICAL FIELD

This invention relates generally to the development of radiation-therapy treatment plans using information gleaned from multi-dimensional high-energy studies of one or more persons.

### BACKGROUND

Radiation therapy is known in the art. Generally speaking, such therapy involves exposing an unwanted volume on or within a patient's body to high-energy radiation (such as, but not limited to, x-rays). This radiation often serves to destroy the irradiated cellular material and hence reduce or eliminate the unwanted volume. In many cases such radiation is periodically administered over time (days, weeks, or months).

Unfortunately, this radiation does not inherently discriminate between wanted and unwanted portions of the patient's body. Treatment plans are therefore formulated to both ensure appropriate irradiation of the unwanted volume while at least attempting, in various ways, to minimize exposing wanted volumes to the radiation. These treatment plans are often based, at least in part, upon one or more multi-dimensional high-energy studies that include the patient's treatment volume. Computed tomography (CT) scans are one common example in these regards. CT-based studies can yield images, for example, that identify the location and boundaries of the unwanted volume and this information, in turn, can serve to permit appropriate programming of the radiation-treatment administration platform.

In many cases the patient's physical circumstances will change over the course of such a treatment regimen. The unwanted volume itself, for example, can become reduced in size and/or move in some respect. As another example, the patient themselves may gain, or lose, weight. And as yet another example, other structures within the patient can change shape or orientation. To accommodate such changes, it is known to update the information available to the treatment planning process during the overall course of a protracted treatment regimen.

As one simple approach, one could simply re-conduct a full CT study of the patient to ensure a proper understanding of such placement, orientation, and dimensional issues. This, however, presents new concerns. Such a study represents considerable cost and time and can also tax the availability of the high-energy image-collection apparatus. This approach may also ultimately involve exposing the patient to a considerable amount of unwanted radiation due to the relative expanse of the study.

As another approach, it is known to attempt to fuse limited current information regarding the patient with other (older) more complete information to provide a resultant view that is both more complete than the smaller current information while avoiding the need to re-expose the patient to the process of acquiring a full current view thereof. Unfortunately, such approaches typically require projecting some or all of the information into sinogram space in order to make effective use thereof. The latter, unfortunately, can be computationally intensive and require either processing resources and/or processing time that outstrips available resources in these regards. Furthermore, in many cases this sinogram data is not initially available as storing such data can challenge even generous storage capacity.

### BRIEF DESCRIPTION OF THE DRAWINGS

The above needs are at least partially met through provision of the method and apparatus to facilitate development of therapeutic treatment plans described in the following detailed description, particularly when studied in conjunction with the drawings, wherein:

FIG. 1 comprises a flow diagram as configured in accordance with various embodiments of the invention;

FIG. 2 comprises a schematic top plan view as configured in accordance with various embodiments of the invention;

FIG. 3 comprises a schematic top plan view as configured in accordance with various embodiments of the invention;

FIG. 4 comprises a schematic top plan view as configured in accordance with various embodiments of the invention; and

FIG. 5 comprises a block diagram as configured in accordance with various embodiments of the invention.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, a digital image processing apparatus acquires first information comprising a first multi-dimensional high-energy study of a given treatment volume for a given person. This apparatus then combines this first information with second information that comprises a second multi-dimensional high-energy study of a given volume for a person that includes, but also exceeds, the given treatment volume. This second multi-dimensional high-energy study precedes in time the first multi-dimensional high-energy study. This combination yields resultant multi-dimensional high-energy image information for the given treatment volume that includes imaging information beyond the given treatment volume. The apparatus then uses this resultant information to facilitate development of a treatment plan for the given person without requiring a projection of the multi-dimensional high-energy image information into sinogram space.

By one approach, the aforementioned first information can be acquired using a first high-energy image-collection apparatus. The second information, in turn, can be acquired using a second high-energy image-collection apparatus that is different from the first high-energy image collection apparatus. Such information can comprise, for example, radiographic studies.

By one approach, the aforementioned imaging information that is beyond the given treatment volume can comprise, at least in part, imaging information for at least one body outline (such as a skin boundary), one or more bones, and/or one or more organs or tissues of interest (such as a lung) for the person.

The aforementioned combination of the first and second information can comprise, by one approach, registering at least one structure as corresponds to the given person and that is present in the first information with a similar (up to and including an identical) structure as is also present in the second information. Such a structure might comprise, for example, a natural structure or an implanted item.

Using these teachings permits such information to be combined and used in a way that avoids projecting the information into sinogram space as is typically required by the prior art. This, in turn, greatly simplifies the use of such information. Beneficial results are therefore attainable in less time and/or by use of less computationally-capable equipment. This can lead to reduced costs and/or less delay while maintaining or exceeding typically attainable results in these regards.

In particular, information comprising a region of interest and that is missing from a present current limited image data set is extendable by referring to previously-acquired image data by, for example, matching one or more portions of the old image to the new image. This can comprise, for example, forming a model of structures outside the limited image data set by extending structure information outside this limited image by assuming Hounsfield units for these structures. This can be done, for example, by matching the patient's body outline from the limited data set to a body outline in the older content to thereby continue the patient's body outline beyond the limited range of the current image data set. These Hounsfield values can then serve, for example, to facilitate calculation of radiation-therapy doses for the corresponding treatment volume.

These teachings are readily employed in conjunction with existing radiographic studies and treatment-planning methodologies and hence can serve to greatly leverage the presence of such information, processes, and equipment. These teachings are also highly scalable and can be employed across a wide variety of methodologies and equipment.

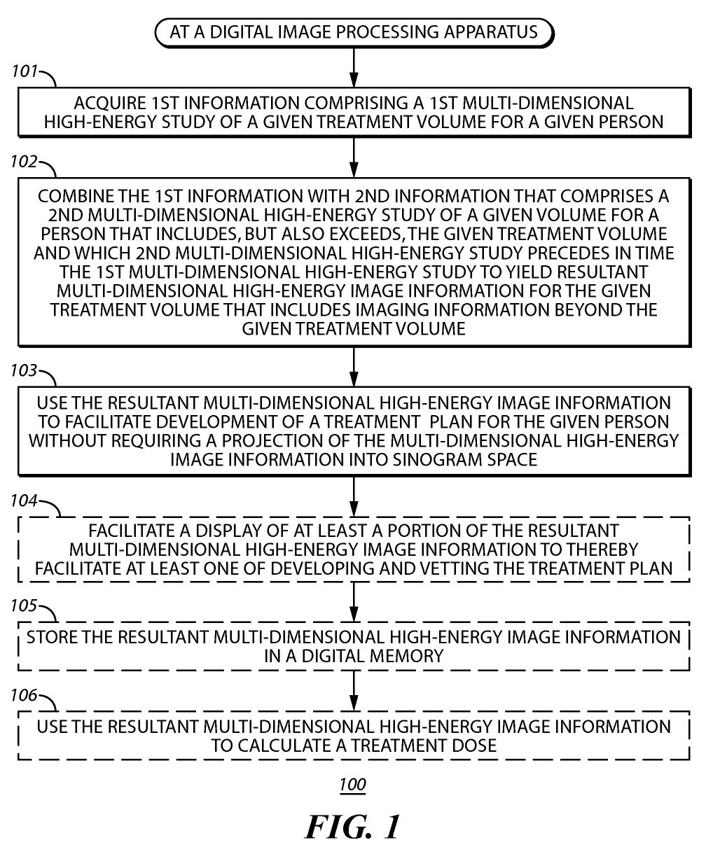

These and other benefits may become clearer upon making a thorough review and study of the following detailed description. Referring now to the drawings, and in particular to FIG. 1, an illustrative process 100 that is compatible with many of these teachings will now be presented. This process 100 can be carried out by a digital image processing apparatus as described below in more detail.

At step 101 this process 100 acquires first information comprising a first multi-dimensional high-energy study of a given treatment volume for a given person. This reference to “multi-dimensional” includes two dimensional, three dimensional, and even four dimensional (where time might comprise, for example, a fourth dimension) or beyond. This reference to “high-energy” includes radiographic energies, positron emission tomography energies, magnetic resonance imaging energies, and so forth. This reference to “study” includes both datasets that would be considered complete (such as a complete computed tomography dataset) as well as datasets that, though sufficient to support the needs of these teachings, may otherwise be considered incomplete or even insufficient to serve as an adequate study for other purposes. Accordingly, a “study” can comprise full or partial computed tomography data, full or partial cone beam computed tomography data, full or partial tomosynthesis data, full or partial data from a plurality of radiographs, and so forth. The treatment volume will typically comprise the radiation-treatment target (such as, for example, an unwanted tumor). Accordingly, the given person will typically comprise the patient for whom a treatment is sought.

A first high-energy image-collection apparatus will typically initially acquire the primary data that comprises this first multi-dimensional high-energy study. For the sake of illustration and without any intent to suggest a limitation in these regards, this first multi-dimensional high-energy study will be presumed to comprise a radiographic study. The first information itself can be developed at the time of need or can be previously developed. In a typical application setting this first information will be initially developed relatively close to the time of need in order to better assure that the information correctly represents the given person's state at the time of treatment.

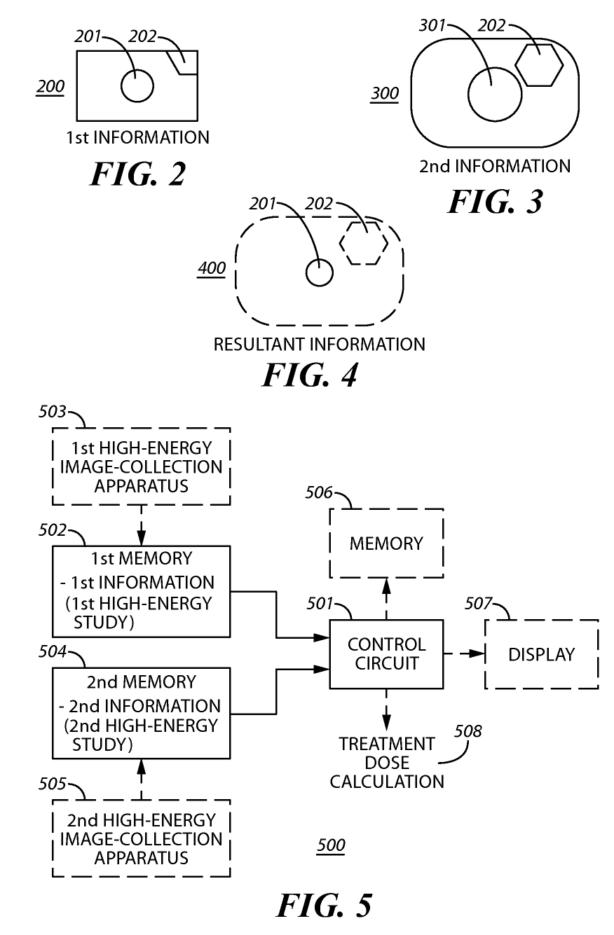

For the purpose of illustration, and again without intending any limitations in these regards, FIG. 2 presents a schematic view of a radiographic image 200 that can comprise, in whole or in part, this first information. This radiographic image 200 includes the given treatment volume 201. This radiographic image 200 also includes a portion comprising a structure 202 that lies beyond the treatment volume 201. This structure 202 might comprise, for example, a natural structure (such as a body outline, a bone, an organ such as a lung, or the like) or an implanted item such as a therapeutic device (such as a pin, artificial joint, pacemaker, or the like) or a marker implanted expressly to aid the described process.

At step 102, this process 100 then combines this first information with second information that comprises a second multi-dimensional high-energy study of a given volume for a person (who may, or may not, be the same person as the aforementioned given person). This second information includes, but also exceeds, the aforementioned treatment volume. The corresponding second multi-dimensional high-energy study also precedes in time the first multi-dimensional high-energy study to yield. In many application settings this will comprise preceding the first study by at least many days and sometimes weeks, months, or even years. This second multi-dimensional high-energy study can be acquired using the same image-collection apparatus as served to source the first multi-dimensional high-energy study or can be acquired using a second high-energy image-collection apparatus that is different from the first high-energy image-collection apparatus as desired.

This second multi-dimensional high-energy study can again comprise two or more dimensions. There is no particular requirement that the dimensionality of this second study match that of the first study. There is also no particular requirement that the study modalities of these two studies match one another. For the sake of simplicity and illustration, however, it will be presumed here that the second multi-dimensional high-energy study comprises a radiographic study sharing a same modality and dimensionality as the first multi-dimensional high-energy study.

Referring momentarily to FIG. 3, and again for the sake of illustration and not by way of limitation, this second information can comprise a radiographic image 300 that includes a volume 301 that includes the treatment volume. In this illustrative example, the second study occurred weeks prior to the first study and at a time when the tumor that comprises the treatment volume was larger in size.

This second information also includes imaging information beyond the given treatment volume (and, in this example, beyond the boundaries of the imaging information as comprises the aforementioned first study). To illustrate this point, the radiographic image 300 of FIG. 3 includes a more complete depiction of the aforementioned structure 202 that lies beyond the treatment volume. For example, this second information might comprise a complete image as pertains to the patient's entire torso while the first information comprises a considerably more constrained view of only the treatment volume and a small area thereabout.

The combination effected by step 102 yields resultant multi-dimensional high-energy image information for the given treatment volume that includes imaging information beyond the given treatment volume. Such a combination can comprise, for example, orienting the two images to place one or more points of reference in both images in registration with one another and then using at least some mutually exclusive information from both images to form a composite image. This might comprise, for example, using all of the content from the first information and supplementing that content with data from the second information for portions that are not represented in the first information.

FIG. 4 presents a simple illustrative example in these regards. In this figure, the first and second information shown in FIGS. 2 and 3 has been selectively combined such that the resultant image 400 includes all of the content of the first information (shown in solid lines and including the treatment volume 201 and a portion of the additional structure 202) and additional extended content drawn from the second information (shown in dashed lines and including a remaining portion of the additional structure 202). Generally speaking, this can comprise registering and then selectively combining two already-reconstructed images to yield a third image that represents the fusing of information from both of these already-reconstructed images.

By one approach, the aforementioned imaging information that lies beyond the given treatment volume can comprise, at least in part, imaging information expressed in Hounsfield units. Hounsfield units, of course, comprise a scale often used in conjunction with computed tomography scanners and represents a scale that is calibrated with reference to water. Using this scale, for example, air is defined as −1000 HU and water is defined as 0 HU. Fat is about −120 HU while muscle reads about +40 HU and bone reads +400 HU or more.

If desired, this step 102 of combining the first information with the second information can comprise, in whole or in part, using deformable registration of the first information and the second information. As one illustrative example in these regards, a deformable registration can be generated between a computed tomography (CT) image and a cone beam computed tomography (CBCT) image. This generated deformable registration can then serve to transform the CT image so that this image matches the image features in the CBCT image in a region (or regions) where the two images intersect with one another. If desired, deformation of the CT image near the boundaries of this region of intersection can fade from, for example, 100% to 0% deformation at given distances from the boundary itself.

Referring again to FIG. 1, at step 103 this process 100 then uses this resultant multi-dimensional high-energy image information to facilitate development of a treatment plan for the given person. For example, the resultant larger view of the area around the treatment volume can serve to inform the development of beam shaping to ensure adequate dosing of the treatment volume while avoiding, to an extent possible, collateral exposure issues to non-targeted tissue. Importantly, these teachings yield resultant image information that can readily serve for this purpose without requiring a projection of the multi-dimensional high-energy image information into sinogram space as is typically required by prior art approaches in these regards. This, in turn, saves considerable computational and/or storage requirements and/or time.

By one approach, this process 100 will then accommodate the step 104 of facilitating a display of at least a portion of the resultant multi-dimensional high-energy image information to thereby facilitate, for example, developing and vetting a treatment plan (and in particular a radiation-therapy treatment plan) for the given person as regards the treatment volume. Various approaches are known in the art to develop such treatment plans. Accordingly, no further elaboration in these regards will be provided here.

Also if desired, this process 100 will accommodate the step 105 of storing the resultant multi-dimensional high-energy image information in a digital memory of choice. This can comprise local storage or storage at a remote location (such as in another building, another municipality, another country, another continent, and so forth).

And also if desired, this process 100 will accommodate the step 106 of using the resultant multi-dimensional high-energy image information to actually calculate a corresponding treatment dose in patient with specific treatment delivery parameters. Again, such calculations comprise a well-understood area of endeavor and require no further explanation here. This process's information can also serve, if desired, to inform the changing of one or more treatment delivery parameters based on human interpretation of the information.

The above-described processes are readily enabled using any of a wide variety of available and/or readily configured platforms, including partially or wholly programmable platforms as are known in the art or dedicated purpose platforms as may be desired for some applications. Referring now to FIG. 5, an illustrative approach to such a platform will now be provided.

In this example, the digital image processing apparatus 500 comprises a control circuit 501 that operably couples to a first memory 502 (which stores the aforementioned first information comprising the first multi-dimensional high-energy study of a given treatment volume for a given person as developed, for example, by a first high-energy image-collection apparatus 503) and to a second memory 504 (which stores the aforementioned second information comprising the second multi-dimensional high-energy study of a given volume for a person that includes, but also exceeds, the given treatment volume and which second multi-dimensional high-energy study precedes in time the first multi-dimensional high-energy study as developed, for example, by a second, different high-energy image-collection apparatus 505). These memories 502 and 504 can be local (in that they are immediately proximal to or integral to the control circuit 501) or can be remotely located as desired.

Such a control circuit 501 can comprise a fixed-purpose hard-wired platform or can comprise a partially or wholly programmable platform. Such architectural options are well known and understood in the art and require no further description here. In any event, this control circuit 501 can be configured (using, for example, programming as will be well understood by those skilled in the art) to carry out one or more of the steps, actions, and/or functions described herein. For example, this control circuit 501 can be configured to access the first and second information and to make the described combination to yield the described resultant multi-dimensional high-energy image information and to use that information as described herein.

If desired, this apparatus 500 can optionally comprise an additional memory 506 (which may be the same, partially or wholly, as the first and/or the second memories 502 and 504 or discrete therefrom) that communicatively couples to the control circuit 501. This additional memory 506 can serve, for example, to receive and store the aforementioned resultant multi-dimensional high-energy image information if desired. This apparatus 500 can also optionally include an end-user interface such as a display 507. This display 507 can communicatively couple to the control circuit 501 and can serve, for example, to provide a display of part or all of the resultant multi-dimensional high-energy image information.

This control circuit 501 can also provide an output, if desired, that directly comprises a calculated, or serves as the basis for calculating a, treatment dose 508 as corresponds to a treatment plan for the given treatment volume for this given person.

Such an apparatus 500 may be comprised of a plurality of physically distinct elements as is suggested by the illustration shown in FIG. 5. It is also possible, however, to view this illustration as comprising a logical view, in which case one or more of these elements can be enabled and realized via a shared platform. It will also be understood that such a shared platform may comprise a wholly or at least partially programmable platform as are known in the art.

These teachings can be deployed, if desired, using a software-based embodiment. So configured, these teachings are readily employed in conjunction with already-fielded equipment as well as with new platforms. Such an approach will also support an economical deployment.

These teachings have a clear and beneficial value when utilized in adaptive radiation therapy treatment methodologies that adapt the treatment in response to new patient information and particularly in application settings where the new information is obtained using only a limited set of acquisition tools and/or exposure/capture constraints (which lead, in turn, to an imaging region that is less than what might best serve the treatment planning approach of choice). Using these teachings previously-obtained image information that contains a more complete presentation can be readily leveraged to form a model of the patient that combines information from both images. This can permit, for example, a treatment setting such a multiple-field non-coplanar IMRT treatment (where radiation will typically enter the patient over a large area) to be successfully implemented notwithstanding only a relatively narrow view of the treatment volume itself.

As a very specific illustrative example in these regards, with a patient presenting a head-and-neck treatment scenario, the treatment area may be 20 cm in the axial direction but the current imaging region is limited to only 15 cm in that direction. In such a case the 15 cm region is represented using the current imaging information (i.e., the first information) while the remaining 5 cm is modeled based on prior information (i.e., the second information) that has been matched via these teachings to the current imaging information.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. As but one example in these regards, the newly-available information can be combined with more than just one previously-obtained image/study. As a simple illustrative example in these regards, a first prior study may provide useful information to the left of the treatment volume while a second prior study may provide useful information to the right of the treatment volume. These teachings can serve to combine the present treatment volume information with the left and right-side information from these first and second prior studies to yield a corresponding composite.

We claim:

1. A method comprising:
at a digital image processing apparatus:
acquiring first information comprising a first multi-dimensional high-energy study of a given treatment volume for a given person;
combining the first information with second information that comprises a second multi-dimensional high-energy study of a given volume for a person that includes, but also exceeds, the given treatment volume and which second multi-dimensional high-energy study precedes in time the first multi-dimensional high-energy study to yield resultant multi-dimensional high-energy image information for the given treatment volume that includes imaging information beyond the given treatment volume;
using the resultant multi-dimensional high-energy image information to facilitate development of a treatment plan for the given person without requiring a projection of the multi-dimensional high-energy image information into sinogram space.

2. The method of claim 1 wherein the step of acquiring the first information comprises acquiring the first information from a first high-energy image-collection apparatus.

3. The method of claim 2 wherein the step of combining the first information with second information comprises acquiring the second information from a second high-energy image-collection apparatus that is different from the first high-energy image-collection apparatus.

4. The method of claim 1 wherein the imaging information for a person beyond the given treatment volume comprises, at least in part, imaging information for at least one of body outline, a bone, and a lung for the person.

5. The method of claim 1 wherein combining the first information with the second information comprises, at least in part, registering at least one structure as corresponds to the given person as is present in the first information with a similar structure as is also present in the second information.

6. The method of claim 5 wherein the at least one structure comprises a natural structure.

7. The method of claim 5 wherein the at least one structure comprises an implanted item.

8. The method of claim 1 wherein the imaging information beyond the given treatment volume comprises, at least in part, imaging information expressed in Hounsfield units.

9. The method of claim 1 wherein the first and second high-energy study each comprise a radiographic study.

10. The method of claim 1 further comprising at least one of:
facilitating a display of at least a portion of the resultant multi-dimensional high-energy image information to thereby facilitate at least one of developing and vetting the treatment plan;
storing the resultant multi-dimensional high-energy image information in a digital memory;
using the resultant multi-dimensional high-energy image information to calculate a treatment dose.

11. The method of claim 1 wherein combining the first information with second information comprises, at least in part, using deformable registration of the first information with the second information.

11. An apparatus, comprising:
a first memory having stored therein first information comprising a first multi-dimensional high-energy study of a given treatment volume for a given person;
a second memory having stored therein second information that comprises a second multi-dimensional high-energy study of a given volume for a person that includes, but also exceeds, the given treatment volume and which second multi-dimensional high-energy study precedes in time the first multi-dimensional high-energy study;
a control circuit operably coupled to the first memory and the second memory and being configured to combine the first information with the second information to yield resultant multi-dimensional high-energy image information for the given treatment volume that includes imaging information beyond the given treatment volume and wherein the control circuit has a display output and is configured to output information representing at least a portion of the resultant multi-dimensional high-energy image information without requiring a projection of the multi-dimensional high-energy image information into sinogram space to thereby facilitate at least one of developing and vetting a treatment plan as corresponds to the given treatment plan.

12. The apparatus of claim 11 wherein the first information comprises information acquired from a first high-energy image-collection apparatus.

13. The apparatus of claim 12 wherein the second information comprises information acquired from a second high-energy image-collection apparatus that is different from the first high-energy image-collection apparatus.

14. The apparatus of claim 11 wherein the imaging information beyond the given treatment volume comprises, at least in part, imaging information for at least one of body outline, a bone, and a lung.

15. The apparatus of claim 11 wherein the control circuit is configured to combine the first information with the second information by, at least in part, registering at least one structure as corresponds to the given person as is present in the first information with similar structure as is also present in the second information.

16. The apparatus of claim 15 wherein the at least one structure comprises a natural structure.

17. The apparatus of claim 15 wherein the at least one structure comprises an implanted item.

18. The apparatus of claim 11 wherein the imaging information beyond the given treatment volume comprises, at least in part, imaging information expressed in Hounsfield units.

19. The apparatus of claim 11 wherein the first and second high-energy study each comprise a radiographic study.
